(19) United States
(12) Patent Application Publication
(10) Pub. No.: US 2008/0272516 A1
(43) Pub. Date: Nov. 6, 2008

(54) Successive Shrinking of Elastomers - a Simple Miniaturization Protocol to Produce Micro- and Nano-Structures

(75) Inventors: Gang-Yu Liu, Davis, CA (US); Jun Hu, Shanghai (CN); Li Tan, Fremont, CA (US); Maozi Liu, Fremont, CA (US)

Correspondence Address: MORRISON & FOERSTER LLP, 425 MARKET STREET, SAN FRANCISCO, CA, 94105-2482, US

(73) Assignee: THE REGENTS OF THE UNIVERSITY OF CALIFORNIA, Oakland, CA (US)

(21) Appl. No.: 11/915,736

(22) PCT Filed: May 30, 2006
(86) PCT No.: PCT/US2006/020985

§ 371 Date: Nov. 27, 2007

Related U.S. Application Data
(60) Provisional application No. 60/685,210, filed on May 27, 2005.

(51) Int. Cl. B28B 7/30

(52) U.S. Cl. 264/313; 977/887

(57) ABSTRACT

A stepwise contraction and adsorption nanolithography (SCAN) patterning process can shrink complex microstructures (produced by current microfabrication technology) into the nanometer region. The basis of SCAN is to transfer a pre-engineered microstructure onto a extended elastomer. This extended elastomer is then allowed to relax, reducing the microstructure accordingly. The new miniaturized structure is then used as a stamp to transfer the structure onto another stretched elastomer. Through iterations of this procedure, patterns of materials with pre-designed geometry are miniaturized to the desired dimensions, including sub-100 ran. The simplicity and high throughput capability of SCAN make the platform a competitive alternative to other micro- and nanolithography techniques for potential applications in multiplexed sensors, non-binary optical displays, biochips, nanoelectronics devices, and microfluidic devices.

### CROSS-REFERENCE TO RELATED APPLICATIONS

This application claims the benefit under 35 USC 119(e) of U.S. Provisional Application No. 60/685,210, filed May 27, 2005, which is incorporated in its entirety herein by reference.

### STATEMENT REGARDING FEDERALLY SPONSORED RESEARCH OR DEVELOPMENT

This invention was made with Government support under Grant (or Contract) No. 60NANBID0072 from the National Institute of Standards and Technology and No. CHE 0244830 from the National Science Foundation. The US Government has certain rights in the invention.

### BACKGROUND

1. Field

The present application relates generally to patterning of materials and components at the micrometer or nanometer scale. Specifically, the present application describes patterning to achieve pattern miniaturization and simultaneously increase pattern density.

2. Related Art

Patterning materials in micro- or nanometer scale is desired in many scientific and engineering fields, such as gratings for wavelength-tunable laser generation in optics, (Lawrene et al., 2003) narrow gate-width transistors in electronics, (Arias, et al. 2004) and portable biosensors (Su et al, 2003). Requirements for these applications hot only include small dimensions in active components, but also a large pattern density to assist yield evaluation and to increase device efficiency.

Difficulties are often encountered during patterning of multiple components at designated locations in reduced dimensions. Micropatterning usually requires multiple stamping and registration steps or a delicate design of a 3-D stamp structure to allow fluidic flowing of those chemicals to specified locations (Tien et al., 2002). Applications of multi-component patterns include non-binary optical displays and microseparation devices. Extreme complexity with the above fabrication approaches is expected when nanometer sized features are demanded.

In photolithography, microarrays of biological probes (Fodor et al., 1991, Kane et al., 1999, and Buesa et al., 2004) are produced via sequential illumination of a photosensitive reagent through differently addressed masks. Although photolithography has demonstrated the potential to continuously break the resolution limit (Levenson et al., 1993), the sky-high cost of instruments and integration difficulties with various materials have put a limit on its widespread use. Scanning probe lithography (Xu et al., 1999, Liu et al., 2000, Piner et al., 1999) can provide high spatial precision in fabrication and characterization of nanostructures; however, this method suffers the drawback of low throughput. Next-generation lithography techniques such as soft lithography (Wilbur et al., 1994, Kumar et al., 1995, Xia et al., 1998, Kane et al., 1999) and imprint techniques (Chou et al., 1996, Bailey et al., 2002) generally share the same characteristics: cost-effectiveness and high resolution. However, these approaches are also well known as IX techniques as fabricated patterns are exclusively negative or positive replicas of the casting molds and thus both the pattern dimension and density are not tunable.

Microlithography has reached a level of maturity such that multi-component and complex microstructures can be produced with high throughput. Alternative lithography techniques such as soft lithography (Chiu et al, 2000 et al., 2000, Wilbur et al., 1994, Kumar et al., 1995, Xia et al., 1998, Tien et al., 2002, and Chen et al., 2003) and writing techniques (Hong et al., 1999, Xu et al., 2000, Sirringhaus et al., 2000, Liu et al., 2000, and Bullen et al., 2004) have produced hierarchical microstructures on a broad range of materials including non-flat surfaces. Further miniaturization, though, is not trivial due to the precision requirements in mask making and alignments between steps (Tien et al., 2002).

While microfabrication is relatively established, the production of multi-component micro- and nanostructures with high density still presents difficulties. The procedures often require sequential applications of micro- and nanolithography, and the precise alignment of each individual component during miniaturization becomes progressively more challenging (Fodor et al., 1991, Hong et al., 1999, Chiu et al., 2000, Su et al., 2003, Zaugg et al, 2003). There is thus a need for a simple, cost effective approach to miniaturize microstructures consisting of multiple components and features.

### SUMMARY

In one exemplary embodiment, a microstructure or nanostructure is produced by first obtaining an extended elastomer. A pattern is then produced on the extended elastomer. The extended elastomer is allowed to relax to convert the pattern to produce a microstructure or nanostructure.

In another exemplary embodiment, a microstructure or a nanostructure is produced by first obtaining a first extended elastomer and a second extended elastomer. A pattern is produced on the first extended elastomer. The first extended elastomer is allowed to relax to convert the pattern to produce a first reduced-size pattern. The first reduced-size pattern is transferred to the second extended elastomer. The second extended elastomer is allowed to relax to convert the first reduced-size pattern to produce a second reduced-size pattern.

In another exemplary embodiment, a microstructure or a nanostructure is produced by first extending a first elastomer to produce a first extended elastomer. A pattern is produced on the first extended elastomer. The first extended elastomer is allowed to relax, to convert the pattern to produce a first reduced-size pattern. A second elastomer is extended to produce a second extended elastomer. The first reduced-size pattern is transferred to the second extended elastomer. The second extended elastomer is allowed to relax, to convert the first reduced-size pattern on the second extended elastomer to produce a second reduced-size pattern.

### DESCRIPTION OF DRAWING FIGURES

FIG. 1 illustrates a Balloon analogy of Stepwise Contraction and Adsorption Nanolithography (SCAN), in which the word “SCAN” on a balloon is miniaturized upon deflation.

FIG. 2 illustrates a schematic of the SCAN procedure.

FIG. 3A illustrates a photograph of the 1D SCAN stretching apparatus with original ink lines drawn on a latex surface.

FIG. 3B illustrates ink lines after one SCAN cycle.

FIG. 3C illustrates the resulting structures after the second SCAN cycle.

FIG. 3D illustrates the resulting structures after the third SCAN cycle.

FIG. 4A illustrates atomic force microscopy (AFM) images of an original master, with a line width of 300 nm and a pitch size of 1.2 μm. Scale bar=1 μm.

FIG. 4B illustrates the miniaturized structure after one SCAN cycle, with 30±6 nm line width and 90±6 nm pitch size, Scale bar=274 nm.

FIG. 5A illustrates a laser confocal fluorescence micrograph of an alternating array of red (λₘₐₓ=640 nm) and green fluorescent (λₘₐₓ=543 nm) inks generated after one SCAN cycle. Scale bar=500 μm.

FIG. 5B illustrates a laser confocal fluorescence micrograph of an alternating array of red (λₘₐₓ=640 nm) and green fluorescent (λₘₐₓ=543 nm) inks generated after three SCAN cycles. Scale bar=234 μm.

FIG. 5C illustrates a laser confocal fluorescence micrograph of an alternating array of red (λₘₐₓ=640 nm) and green fluorescent (λₘₐₓ=543 nm) inks generated after five SCAN cycles. Scale bar=34 μm.

FIG. 6 shows a laser confocal fluorescence micrograph of a protein array generated by SCAN. Scale bar=220 μm.

FIG. 7 shows a laser confocal fluorescence micrograph of a double component oligonucleotide array generated by SCAN. Scale bar=500 μm.

FIG. 8 illustrates the scheme of the modified Stepwise Contraction and Adsorption Nanolithography (mSCAN) technique.

FIG. 9A illustrates AFM topographic images of a primary poly(dimethylsiloxane) (PDMS) mold (P1). The parent Si mold is shown in the inset.

FIG. 9B illustrates AFM topographic images of a secondary PDMS mold (P2).

FIG. 10A illustrates an AFM topographic image of a patterned bovine serum albumin (BSA) patterns from the PDMS elastomer mold, indicated in FIG. 9A, with an external pressure of 160 kPa.

FIG. 10B illustrates an AFM topographic image of a patterned BSA patterns from the PDMS elastomer mold, indicated in FIG. 9A, with an external pressure of 40 kPa.

FIG. 11 illustrates wave formation in a double-layer elastomer structure. The figure illustrates wave generation during relaxation of the elongated substrate.

FIG. 12 illustrates a cover layer with different thickness (“tapered”) which was cast over an elongated substrate

FIGS. 13A and 13B illustrate AFM images of wave formation on a cover layer with different thickness (“tapered’), as indicated in FIG. 12.

### DETAILED DESCRIPTION

Before explaining at least one exemplary embodiment of the invention in detail, it is to be understood that the invention is not limited in its application to the details of construction and the arrangement of the components set forth in the following description. The invention is capable of other embodiments or of being practiced or carried out in various ways. Also, it is to be understood that the phraseology and terminology employed herein is for the purpose of description and should not be regarded as limiting.

Throughout this disclosure, various publications, patents and published patent specifications are referenced. The disclosures of these publications, patents and published patent specifications are hereby incorporated by reference into the present disclosure to more fully describe the state of the art to which this invention pertains. Unless otherwise noted, technical terms are used according to conventional usage.

Two exemplary techniques, Stepwise Contraction and Adsorption Nanolithography (SCAN), and modified Stepwise Contraction and Adsorption Nanolithography (mSCAN) are described below. These exemplary techniques should be able to extend the advantages of microfabrication into smaller dimensions as well as to reach the spatial precision afforded by scanning probe lithography.

SCAN (Stepwise Contraction and Adsorption Nanolithography) is a new nanofabrication platform that can be used to achieve pattern miniaturization and to increase pattern density. This technique can be used to fabricate micro- or nanometer sized patterns from the millimeter or micrometer scale by repeating the steps of material contraction and adsorption. The pattern can be any design or structure chosen to be miniaturized.

The basis of SCAN is to transfer a pre-engineered microstructure onto a stretched elastic stamp. This stamp is then allowed to relax, reducing the microstructure accordingly. Such allowing may be through affirmative steps, and may occur through facilitation by a device or by a human. Such allowing can also be controlled so as to increase or decrease the speed of relaxation. The new miniaturized structure is then used as a stamp on another stretched elastomer. Through iterations of this procedure, patterns of materials with pre-designed geometry are miniaturized to the desired dimensions, including sub-100 nm. The simplicity and high throughput capability of SCAN make the platform a competitive alternative to other micro- and nanolithography techniques for potential applications in multiplexed sensors (Su et al., 2003), non-binary optical displays (Bao et al., 1999), biochips (Zhu et al., 2003), and microfluidic devices (Quake et al., 2000).

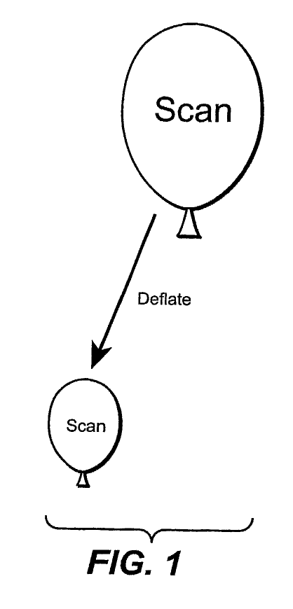

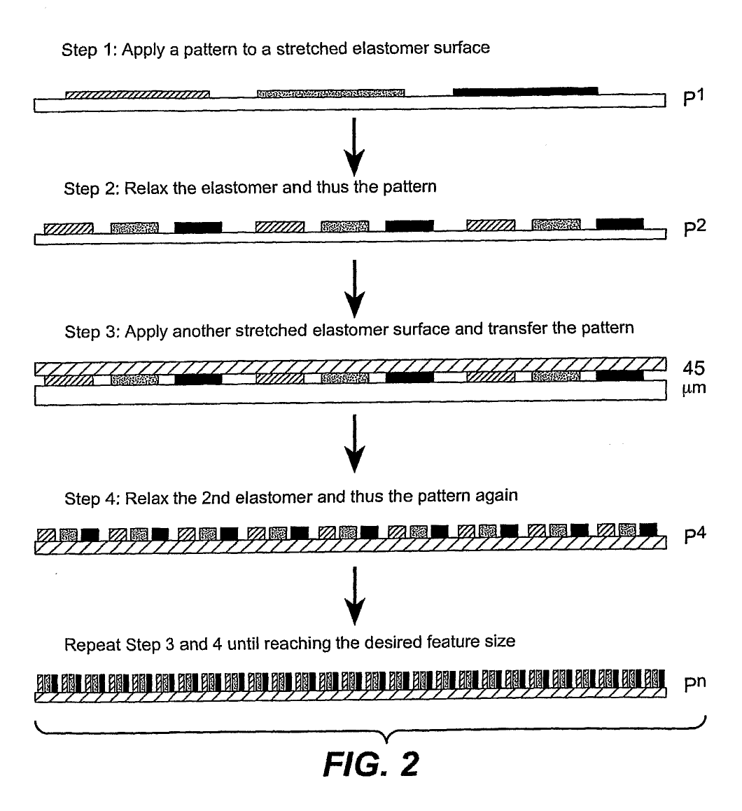

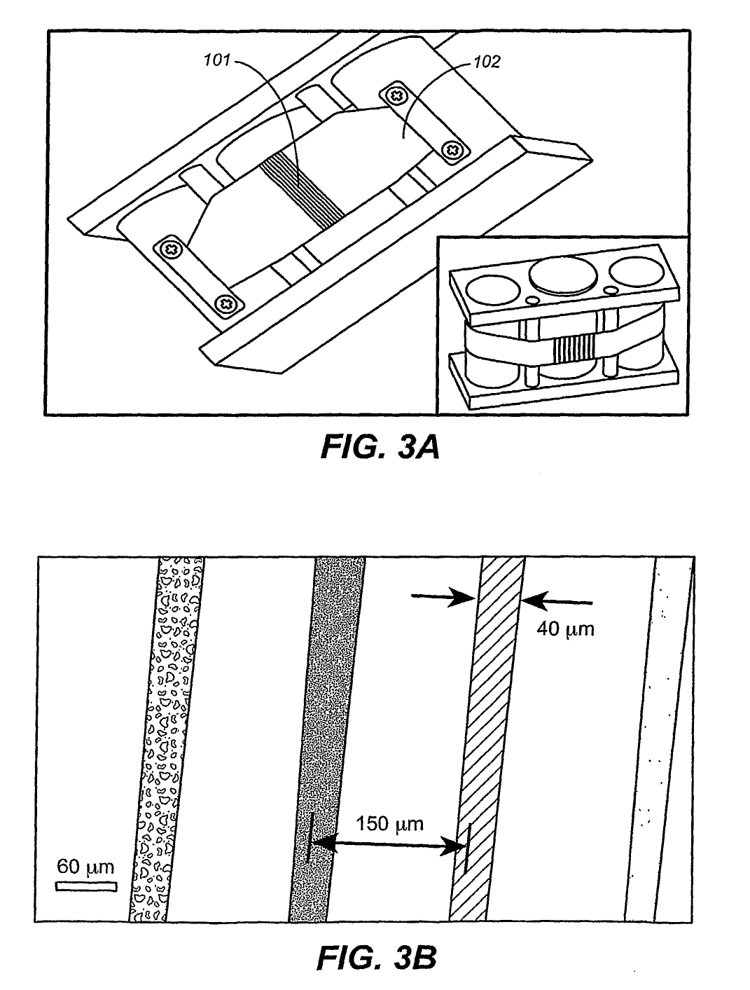

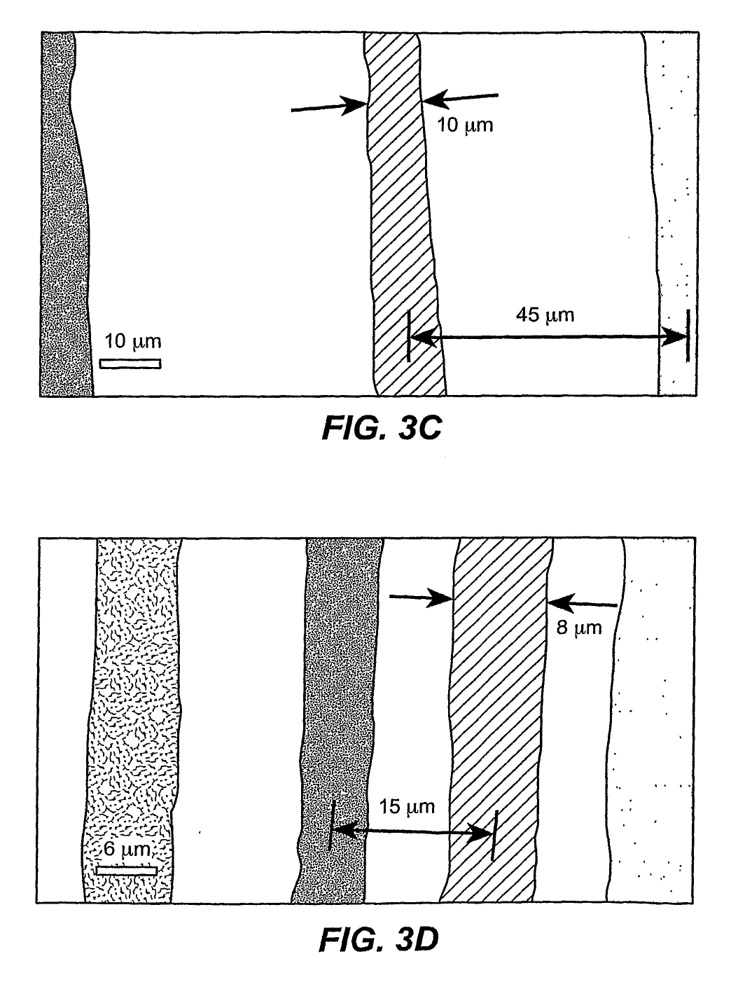

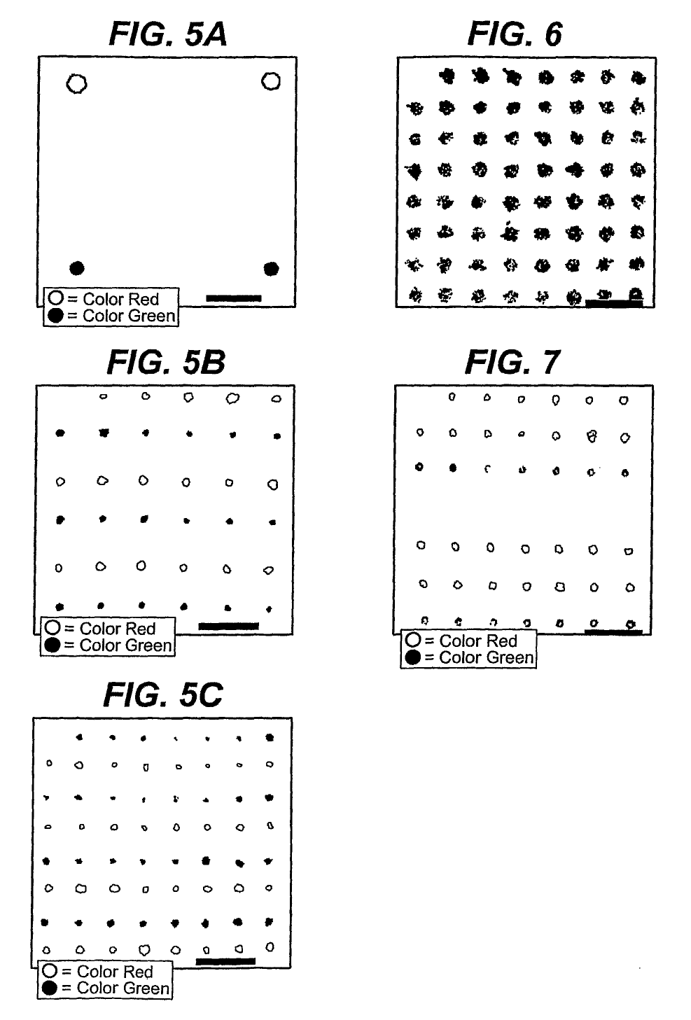

The miniaturization principle of SCAN is illustrated using the balloon analogy shown in FIG. 1, and the key steps are shown schematically in FIG. 2. A synthetic polymer with high elasticity is used as the stamp, and the miniaturization process is derived from the uniform shrinkage of the central area of this elongated substrate (Russell et al., 2002). We note that synthetic polymer is only one kind of material appropriate for use as an elastomer stamp. Any material able to stretch and relax (exhibiting elasticity) may be used as an elastomer stamp Fabrication procedures include: i) the design and production of an original microstructure (P₁) on a stretched rubber surface; ii) the miniaturization of the pattern using the following cycle: relaxing the elongated rubber to form a smaller pattern P₂ and transferring the new structure to another stretched elastomer through contact; iii) repeating this cycle until the final pattern size, Pₙ, is obtained; and iv) the final transferring of the pattern, Pₙ, onto desired surfaces. SCAN can be performed in one or two dimensions depending on the geometry requirements of the final products. For example, a 1D SCAN process would be selected for generating arrays of lines (Example 1, FIGS. 3A, 3B, 3C, and 3D), and an array of dots could be prepared using a 2D SCAN procedure (Example 3, FIGS. 5A, 5B, and 5C).

In comparison with other unconventional lithography methods, there are several advantages of using SCAN as an alternative approach of soft nanolithography. One advantage of SCAN is its simplicity. Structures are created in macroscopic scale and the final fine-scale structures are produced simply through repeating material contraction and material transfer. Thus, SCAN allows fabrication of multiple material components at a micro- or nanometer regime. Secondly, SCAN is expected to be compatible with a variety of materials. Since this process generally involves mechanical deformation of the elastomer substrate, the material to be patterned on such substrate does not require particular thermal or optical properties. Such flexibility is especially advantageous for the production of micro- or nanoarrays of biological materials, such as proteins (such as antibodies) or DNA. Another advantage of SCAN is that it is cost-effective, as there are no complicated instruments or set-up required. Finally, pattern size miniaturization in SCAN is achieved with a simultaneous pattern density increase, which we designate as mX (m=P₁/Pₙ) technique compared to the conventional contact lithography, implying the relative independence of the resolution and pattern density to the casting platform.

Pattern size miniaturization is obtained with a simultaneous pattern density increase, as described by the equation Pₘ=P₁×1/R^{m}, where P₁ is the initial size, Pₘ is the final size after reduction of n times, and R is the elongation ratio, in the case of homogeneous elongation and contraction. For non-homogeneous elongation and contraction, the ratio varies from region to region.

| P₁ | R | m | Pₘ |
|---|---|---|---|
| 1 mm | 10 | 4 | 100 nm |
| 1 mm | 4 | 7 | 60 nm |

We envision the application and integration of SCAN in microwriting (Hong et al., 1999, Zaugg et al., 2003, Sirringhaus et al, 2000, and Roth et al., 2004) and microcontact lithography (Quake et al, 2000, Kane et al., 1999, Wilbur et al., 1994, Chou et al., 1996, and Bailey et al., 2002), in which the advantages of these well-established microlithographies are preserved and the attainable feature sizes are further reduced.

Other materials, such as metal nanoparticles, powders, or luminescent nanoparticles, could be patterned using SCAN. Such processes might even incorporate electric/magnetic fields or laser pulses (Barron et al., 2004) to assist in material transfer between the elastomer surfaces. In addition to SCAN's potential for being integrated with other micro- or nanofabrication platforms, the array of materials that could be patterned using SCAN gives rise to the broad technological impact of this technique.

For processes in which multiple steps of materials transfer is not desirable, modification of SCAN serves to achieve miniaturization without involving many steps of materials transfer. This strategy is designated as modified Stepwise Contraction and Adsorption Nanolithography (mSCAN) to indicate its direct importance to the fabrication of a soft mold in the soft lithography (Xia et al., 1998). mSCAN is a technique that can be used to achieve pattern miniaturization and pattern density with high efficiency. Similar to the SCAN process, this technique is made possible by utilizing the expansion and contraction of an elastomer pad. Similar to soft lithography, a fabricated mold from the mSCAN platform can then be applied to print various materials with a further reduced pattern dimension and an increased pattern density.

As described in Example 5, a shrinkable elastomer mold was cast from a Si mold with a line width of 1.5 μm. As a result, line features on the new mold are reduced from 1.5 μm on the parent Si mold to 240 nm. In addition to the merits of the SCAN platform, mSCAN avoids the tuning of material viscoelasticity in SCAN and has additional merits of high yield and good fidelity.

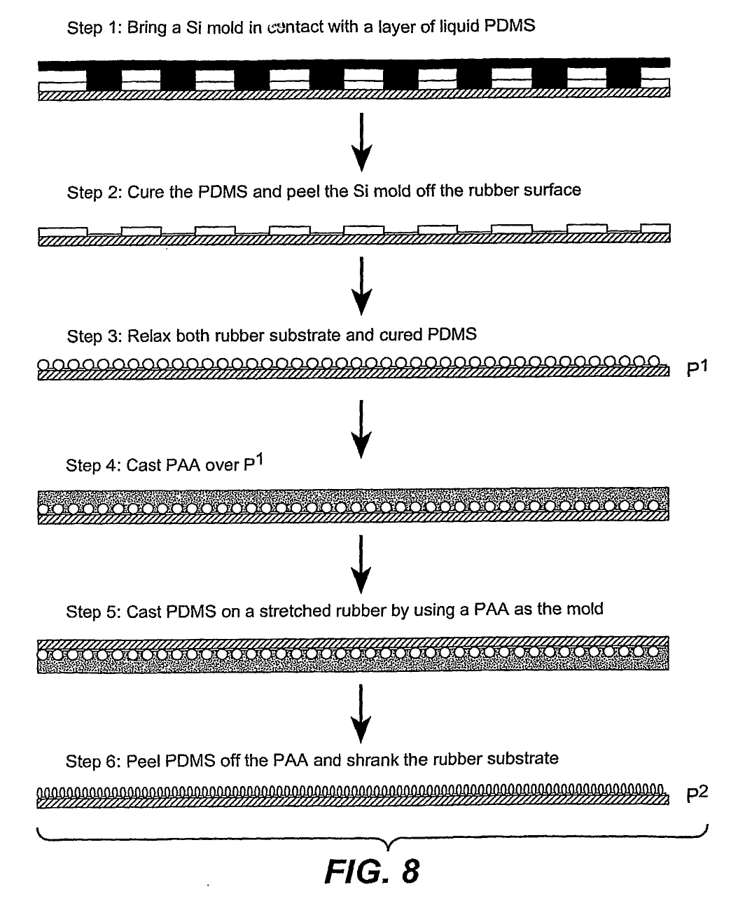

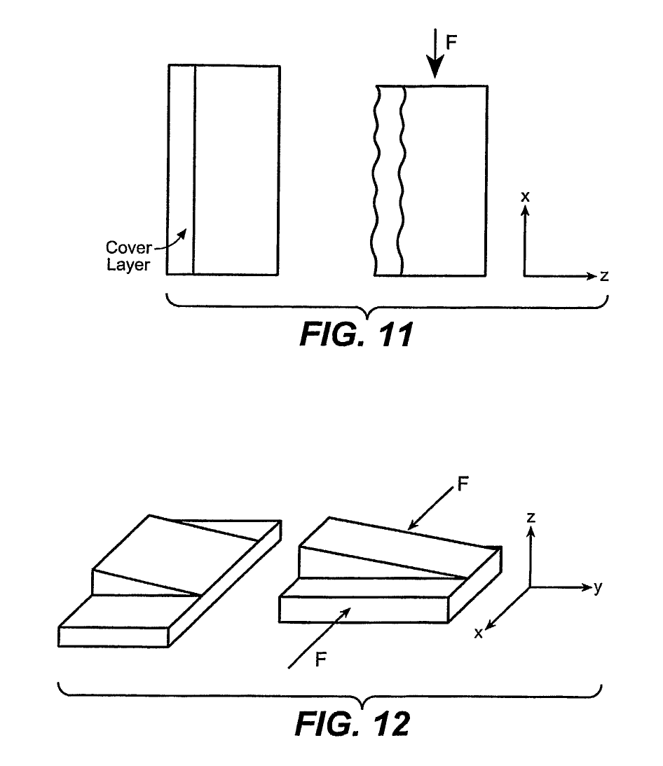

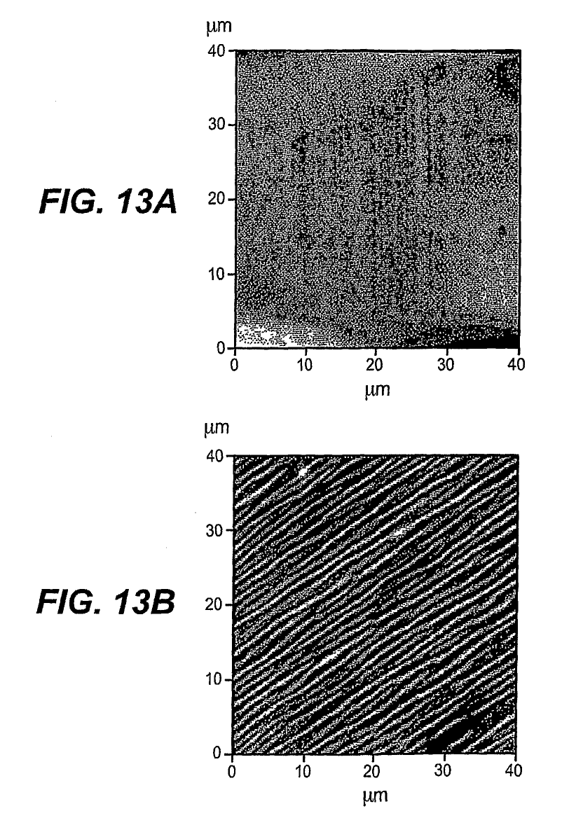

It is also worthwhile to note the appearance of “wave” on surfaces of the fabricated elastic mold after the mSCAN process. We ascribe the double-layer structure of the mold, i.e., PDMS substrate/PDMS mold, being responsible for such “wave” formation. In the relaxation of an elongated elastomer, length reduction in x-direction is always accompanied with an elongation in both z- and y-direction (Russell et al., 2002). And no “waves” on surfaces are expected when such elastomer is free of any boundary material attachment. However, when another media covers this elongated elastomer, vertical deformation (z-direction) of the substrate is then greatly restrained by the media and leads to a periodic height variance in the z-direction which is a wave (Volynskii et al., 1999, Volynskii et al, 2000). This process can be better visualized by the scheme in FIG. 11 and the wavelength of this wave may be semi-quantitatively described by the following equation (Volynskii et al., 1999 and 2000):

$$λ = 2 π \sqrt[6]{\frac{1 + υ}{18}} \cdot \sqrt[3]{\frac{{E}_{1}}{E}} \cdot h$$

in which h stands for the thickness of the covering elastomer layer, υ for the Possion's ratio, and E₁ and E represent Young's modulus of the cover layer and substrate, respectively. Clearly, the wavelength can be tuned by varying the thickness of the cover layer. This relationship is demonstrated as shown in FIG. 12, in which a PDMS cover layer with a tapered structure is cast over an elongated PDMS substrate. The relaxation of the substrate renders waves of different wavelengths on the cover layer. FIGS. 13A and 13B show topography images of those waves and the wavelength is indeed dependent on the cover layer thickness. Furthermore, if the cover layer is not composed by a uniform layer, but by a layer with height contrast such as a grating mold as shown in FIG. 8, a careful control of the cover layer thickness is necessary and the aforementioned principle can be utilized to minimize the influence of the wave to the grating line features. Usually, h can be tuned to establish the relationship of λ>>pitch size of grating lines.

The elastomers used in the present exemplary techniques can be any materials with adequate elasticity. Some non-limiting examples of elastomers include rubber, Poly(dimethylsiloxane) (PDMS) and latex, with and without surface modifications. The elastomers can be extended or stretched in one or two dimensions. The present exemplary techniques can be used to create microstructures of desired sizes, from the micrometer to the nanometer range.

The elastomers of the present exemplary techniques may comprise one or more polymers. The elastomers may comprise different polymers. The polymers can be chosen from rubber, Poly(dimethylsiloxane) (PDMS) and latex, with and without surface modification.

The pattern used in the present exemplary techniques may be a biological material, nanoparticles, nanowires, nanotubes, metals, organic and inorganic materials, or composite materials. The biological material may be nucleotides, peptides, ligands, oligosaccharides, viruses or bacteria, or proteins such as antibodies or antigens. Peptides are referred to herein as two or more amino acids. The pattern may be created by means of a lithography platform such as photolithography, scanning probe lithography, inkjet printing, array technique, imprinting lithography, beam lithography, particle lithography, or microcontact printing.

The transfer of the pattern between the elastomer surfaces can be mediated by an external means such as surface chemistry, surface plasma treatment, electric field treatment, or magnetic field treatment.

The present application also embodies the microstructure or nanostructure of the invention, which can be used as a mold for lithography, such as microlithography or nanolithography, or in optical displays, sensors, biochips, microarrays, nanoarrays or fluidic devices.

The present application also contemplates biomedical or electronic devices comprising the microstructures or nanostructures of the invention.

### EXAMPLE 1

### Miniaturized Multi-Component Line Array

The ability to produce multi-component microstructures is demonstrated in FIGS. 3A, 3B, 3C, and 3D, which contains a photograph of the experimental apparatus (FIG. 3A) and optical micrographs of the resulting miniaturized multi-component line array formed using SCAN (FIGS. 3B-D). The experiments involved first drawing a series of colored lines 101 (FIG. 3A) with a width of 0.2 mm and a separation of 1 mm on the surface of an elongated latex elastomer 102 (Pioneer®, Pioneer Worldwide™). After the first relaxation, the line width was reduced to 40 μm, as shown in FIG. 3B. One more cycle generated the pattern shown in FIG. 3C with a line width of 10 μm and a spacing of 45 μm. The final structure (FIG. 3D) exhibited a width of 8 μm and a spacing of 15 μm. Overall, a 25-fold line width reduction, from 0.2 mm down to 8 μm, was achieved, and the line density (lines per inch or LPI) was increased 80-fold, from 20 LPI (1.2 mm/pitch) to 1700 LPI (15 μm/pitch).

Initially, it was expected that 1D SCAN would exhibit proportional miniaturization along the stretching/shrinking direction, such that the final feature size could be predicted by the equation: Pₙ=P₁×R⁻ⁿ, where R is the stretching ratio of the elastic substrate at each step. However, the results in FIGS. 3A, 3B, 3C, and 3D suggest otherwise, with a 25-fold reduction in line width vs. a 80-fold reduction in spacing. The viscosity of the material to be patterned influences the miniaturization results of SCAN. For solid materials in solvents, complete evaporation of the solvent before the pattern transfer renders rigidity to the pattern and consequently, non-linear and non-uniform shrinkage in inked and blank areas. Typically, the shrinkage ratio of ink is less than that of blank rubber. Solvent concentration was thus tuned to reach the desired viscosity and rigidity.

### EXAMPLE 2

### Production of Bionanostructures

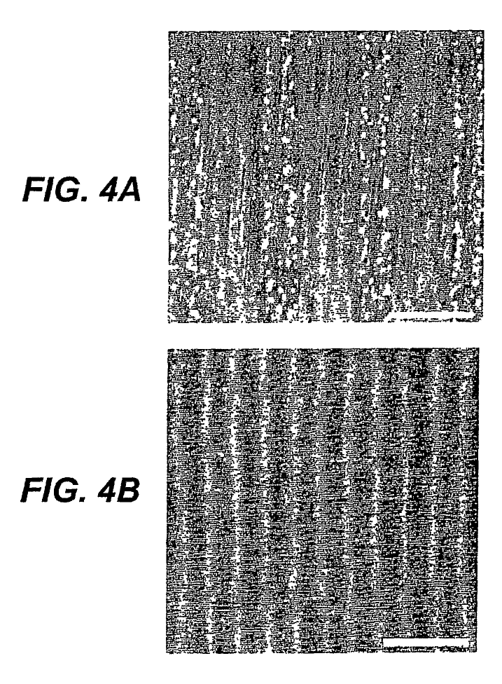

The miniaturization mechanism of SCAN is particularly advantageous when integrated with other well-established microlithography techniques (Kumar et al., 1995, Xia et al., 1998, Chou et al., 1996, Bailey et al., 2002). Microlithography can be utilized to produce original patterns with precision and complexity at the micrometer level, and then SCAN allows further reduction of these structures to a dimension difficult to reach by microfabrication techniques. Hence, the combination of both platforms provides a powerful means to design and generate nanostructures. FIGS. 4A and 4B illustrate the production of bionanostructures in which a PDMS mold with a 1.2 nm pitch was used to cast an array of lines of bovine serum albumin (BSA) onto a piece of 1D stretched rubber (FIG. 4A). In this process, BSA (10 μg/mL) is first spread over a poly(dimethylsiloxance) (PDMS) stamp with grating line features (300 nm line width and a pitch size of 1.2 μm). After drying under a stream of nitrogen, the BSA pattern was transferred to a stretched thermoplastic rubber to form the pattern shown in FIG. 4A. After the tensile stress on the elastomer was released, the pattern was then transferred to mica substrate and imaged using AFM. Relaxation of the elongated elastomer gave rise to a line array consisting of parallel lines with a 90±6 nm pitch (FIG. 4B). Analogous to photocopy reduction, the initial defects, such as discontinuous or broken lines, were significantly healed upon miniaturization (compare FIG. 4A to FIG. 4B). Unlike photocopy reduction, the line width reduction in one direction of the elastomer was always accompanied by an elongation of the pattern along the perpendicular direction (Russell et al., 2002).

### EXAMPLE 3

### 2D SCAN

In 2D SCAN, the elastomer is expanded uniformly in all directions within the experimental plane and homogeneous miniaturization can be attained in the central region of the stamp. As an example, a two dimensional dot microarray of two fluorescent dyes was produced after five SCAN cycles (FIGS. 5A, 5B, and 5C). The original dots had a diameter of 0.5±0.1 mm and 5±1 mm spacing, while the final spot size were 10±1 μm in diameter with 25±1 μm spacing. Correspondingly, the array density (spots per square inch or SPSI) was increased five orders of magnitude from 25 SPSI (1 spot/25 mm²) to 106 SPSI (1 spot/625 μm²). The quality of the miniaturization should be improved significantly if a high quality inkjet technique (Zaugg et al., 2003) or photolithography (Levenson et al., 1993) is used to produce the initial patterns.

### EXAMPLE 4

### Production of Bio-Arrays

The SCAN platform is sufficiently gentle for the production of micro- or nanoarrays of biological materials, such as DNA or proteins, in high throughput and with a good fidelity. For example, FIGS. 6 and 7 show arrays of human immunoglobulin G (IgG) (FIG. 6) and two types of single-stranded DNA (FIG. 7) produced by SCAN.

In FIG. 6, unlabelled human IgG (0.5 mg/mL in PBS buffer, pH 7.0) was used to produce the micrometer-sized array using the SCAN (original sizes of 0.5 mm in spot diameter and 3.5 mm in center spacing, final sizes of 59 μm in diameter and 130 μm in center spacing after 3 cycles of SCAN). The array was then exposed to a FITC tagged (green fluorescence, λₘₐₓ=543 nm) goat-anti-human IgG (60 mg/L) at 37° C. for 30 min. The surface was rinsed thoroughly with PBS to remove any non-specific binding before confocal imaging. In FIG. 7 arrays of microstructures were produced using SCAN (original sizes of 3 mm in center spacing and 0.5 mm spot diameter, final sizes of 330 μm in center spacing and 80 μm spot diameter after 2 cycles of SCAN), using two oligonucleotides (15 mg/L in SSC buffer, PH7.0): 5′-NH₂-AAAAAAAAAA ACC CAA CAC TAC TCG-3′ (designated as ssDNA-1) and 5′-NH₂-AAAAAAAAAA CGA CAG CTG CGA GCC (ssDNA-2). The surface was then exposed to a solution containing the complementary sequences for both ssDNA-1 and ssDNA-2: 5′-FAM-CGA GTA GTG TTG GGT-3′ (green fluorescence, λₘₐₓ=543 nm) and 5′-TAMRA-GGC TCG CAG CTG TCG-3′ (red fluorescence, λₘₐₓ=640 mm). The hybridization was demonstrated by two-colored confocal micrography.

In the case of the antibody arrays, the IgG molecules can be recognized by specific secondary antibodies such as fluorescent tagged goat-anti-human IgG, as shown in FIG. 6. In the case of the DNA arrays, the DNA can bind to complementary single-stranded DNA (ssDNA). Since the complementary ssDNA has two different fluorescent tags λₘₐₓ=640 nm and λₘₐₓ=543 nm), green and red fluorescence are revealed upon specific binding or recognition to individual ssDNA features fabricated by SCAN.

### EXAMPLE 5

### mSCAN

FIG. 8 illustrates the formation of a shrinkable elastomer mold through mSCAN. Poly(dimethylsiloxane) (PDMS) is chosen as the elastomer material since the resulting elastomer pad has a good elasticity and can be stretched 3-4 times without crack or failure. In the mSCAN process, a thin layer of liquid PDMS pre-elastomer (not cured) is firstly coated over an elongated PDMS substrate and a patterned Si mold is then brought into contact with this pre-elastomer (Step 1). In this process, the Si mold was treated with 1H,1H,2H,2H-perfluorodecyltrichlorosilane to have low surface energies (Tan et al., 2004) for mold release after PDMS curing. Intimate contact between the mold and pre-elastomer can be achieved by applying an external pressure, ca. 40 kPa. Subsequently, this whole assembly is baked at 65° C. for 120 min (Xia et al., 1998) to fully cure the PDMS underneath the Si mold (Step 2). Finally, the Si mold is peeled off and a shrinkable elastomer mold (P1) is obtained (Step 3), in which the relaxation of the PDMS substrate could compress mold features upon it laterally.

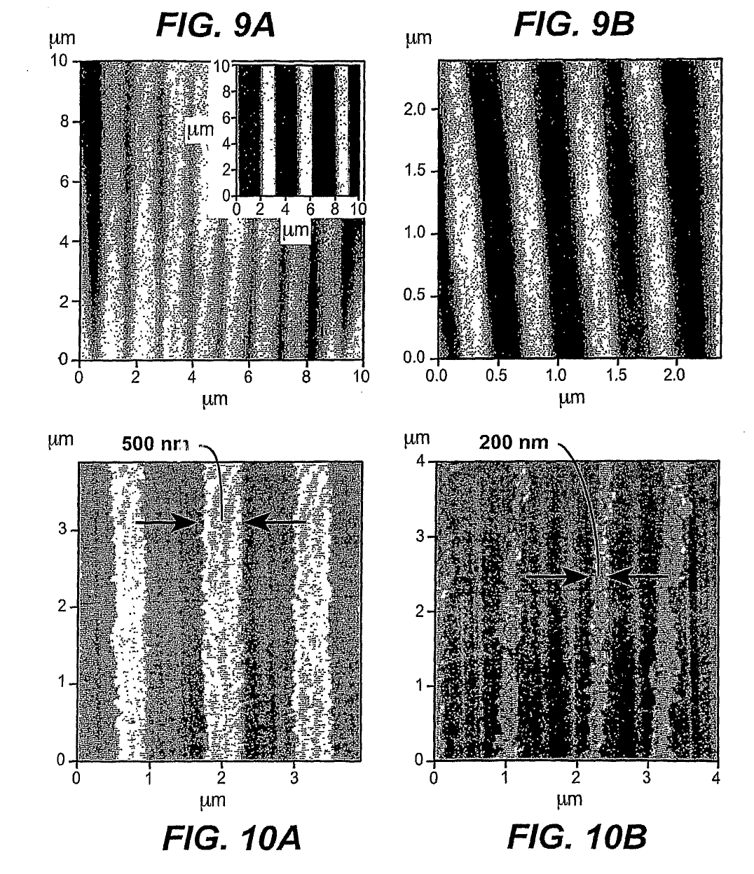

The PDMS substrate with a thickness of 0.5 mm was stretched 4 times before coating a thin layer of liquid PDMS pre-elastomer. The miniaturization procedure was performed as illustrated in FIG. 8 and topographic images of the resulting patterns after substrate relaxing are shown in FIGS. 9A and 9B. Inset of FIG. 9B shows a topography image of a Si grating mold, having a flat plateau with a width of 1.5 μm in the bottom of the protrusions and being spaced 1.5 μm in between. A negative pattern of the Si grating is created in the elastomer mold, in which line width and line spacing was reduced to 800 nm and 400 nm (line pitch size of 1.2 μm, FIG. 4A), respectively. Clearly, a different elastomer thickness in the mold has caused different lateral compression between protrusions and trenches.

Moreover, when the elastomer mold (P1) is further utilized as a casting platform to replace the Si mold in Step 1 of scheme FIG. 8, feature sizes on the mold can be continuously reduced and, correspondingly, pattern density from the Si mold is increased in a stepwise fashion. Specifically, a sacrificial mold composed of poly(acrylic acid) (PAA), i.e., the negative replication of P1, is used for such purpose as shown in FIG. 8 (Steps 4-6). The thermoplastic properties of PAA have rendered it a good candidate to form a sacrificial mold since (a) PAA will not easily deform after pattern replication at a temperature below its glass-transition temperature (80° C.) and (b) PAA does not adhere strongly to the PDMS surface. The latter property allows PAA to be easily released from secondary mold (P1) after film casting, and thus can be used for subsequent tertiary mold (P2) casting. During the sacrificial mold casting process, PAA solution in ethanol (2 wt %) is first spread over the P1 mold surface and then a clear PAA mold with negative features of the P1 is obtained after drying under a stream of nitrogen (Step 4, FIG. 1). Similar to the usage of the Si mold, the PAA mold is then used to create the tertiary mold (P2) (Step 5, FIG. 8). Relaxation of the P2 laterally after releasing the tensile stress on the elongated substrate reduces dimension of the line features, in which line width is reduced from 800 nm (line pitch size of 1.2 μm, FIG. 9B) to 240 nm (line pitch size of 500 nm, FIG. 4B). Further mold replication based on the P2, by following above steps 4-6, is also possible and will surely reduce the pattern dimension to even smaller scale.

### EXAMPLE 6

### Application of mSCAN in Soft Lithography

Similar to μCP (microcontact printing), the fabricated mold from the mSCAN platform can then be applied to print various materials with a miniaturized pattern dimension and an increased pattern density. Since the PDMS mold and the elastic substrate underneath are very thin, a rigid glass slide can be used for backing to avoid undesired deformation in the subsequent printing. It is worthwhile to note that the shrinking process of PDMS in lateral direction has changed the edge profile of protrusions, from square to round. One benefit of this feature is that the mold contact area with the substrate in the subsequent contact printing process can be tuned with different external pressures. As a result, protein patterns with different line width can be fabricated by using the same elastomer mold as shown in FIGS. 10A and 10B. In this proof-of-concept example, a thin layer of BSA in aqueous solution (0.1 wt %) is coated over the P1 mold (indicated in FIGS. 9A and B) and dried over a stream of nitrogen. Subsequently, the elastomer mold is brought into contact with a Si substrate and BSA patterns with a width of 500 μm and 200 nm are obtained at an external pressure of 160 kPa and 40 kPa, respectively.

### REFERENCES

The following references are hereby incorporated by reference in their entirety.
Arias, A. C.; Ready, S. E.; Lujan, R.; Wong, W. S.; Paul, K. E.; Salleo, A.; Chabinyc, M. L.; Apte, R.; Street, R. A.; Wu, Y.; Liu, P.; Ong, B. Appl Phys Lett 2004, 85, 3304-3306.
Bailey, T. C. et al. Step and flash imprint lithography: An efficient nanoscale printing technology. Journal of Photopolymer Science and Technology 15, 481-486 (2002).
Bao, Z. A. & Campbell, S. Patterned multiple color polymer light-emitting diodes. Thin Solid Films 352, 239-242 (1999).
Barron, J. A., Wu, P., Ladouceur, H. D. & Ringeisen, B. R. Biological laser printing: A novel technique for creating heterogeneous 3-dimensional cell patterns. Biomedical Microdevices 6, 139-147 (2004).
Bullen, D. et al. Parallel dip-pen nanolithography with arrays of individually addressable cantilevers. Applied Physics Letters 84, 789-791 (2004).
Buesa, C., Maes, T., Subirada, F., Barrachina, M. & Ferrer, I. DNA chip technology in brain banks: Confronting a degrading world. Journal of Neuropathology and Experimental Neurology 63, 1003-1014 (2004).
Chen, C. C., Hirdes, D. & Folch, A. Gray-scale photolithography using microfluidic photomasks. Proceedings of the National Academy of Sciences of the United States of America 100, 1499-1504 (2003).
Chiu, D. T. et al. Patterned deposition of cells and proteins onto surfaces by using three-dimensional microfluidic systems. Proceedings of the National Academy of Sciences of the United States of America 97, 2408-2413 (2000).
Chou, S. Y., Krauss, P. R. & Renstrom, P. J. Nanoimprint lithography. Journal of Vacuum Science & Technology B 14, 4129-4133 (1996).
Fodor, S. P. A. et al. Light-Directed, Spatially Addressable Parallel Chemical Synthesis. Science 251, 767-773 (1991).
Hong, S. H., Zhu, J. & Mirkin, C. A. Multiple ink nanolithography: Toward a multiple-pen nano-plotter. Science 286, 523-525 (1999).
Kane, R. S., Takayama, S., Ostuni, E., Ingber, D. E. & Whitesides, G. M. Patterning proteins and cells using soft lithography. Biomaterials 20, 2363-2376 (1999).
Kumar, A., Abbott, N. L., Kim, E., Biebuyck, H. A. & Whitesides, G. M. Patterned Self-Assembled Monolayers and Mesoscale Phenomena. Accounts of Chemical Research 28, 219-226 (1995).
Lawrene, J. R.; Turnbull, G. A.; Samuel, I. D. W. Appl Phys Lett 2003, 82, 4023-4025.
Levenson, M. D. Wave-Front Engineering for Photolithography. Physics Today 46, 28-36 (1993).
Liu, G. Y., Xu, S. & Qian, Y. L. Nanofabrication of self-assembled monolayers using scanning probe lithography. Accounts of Chemical Research 33, 457-466 (2000).
Ouyang, Z. Q.; Tan, L.; Liu, M.; Judge, O.; Zhang, X.; Li, H.; Hu, J.; Patten, T. E.; Liu, G. Y. Submitted 2005.
Piner, R. D.; Zhu, J.; Xu, F.; Hong, S. H.; Mirkin, C. A. Science 1999, 283, 661-663.
Quake, S. R. & Scherer, A. From micro- to nanofabrication with soft materials. Science 290, 1536-1540 (2000).
Roth, E. A. et al. Inkjet printing for high-throughput cell patterning. Biomaterials 25, 3707-3715 (2004).
Russell, T. P. Surface-responsive materials. Science 297, 964-967 (2002).
Sirringhaus, H. et al. High-resolution inkjet printing of all-polymer transistor circuits. Science 290, 2123-2126 (2000).
Su, M., Li, S. Y. & Dravid, V. P. Miniaturized chemical multiplexed sensor array. Journal of the American Chemical Society 125, 9930-9931 (2003).
Tan, L.; Kong, Y. P.; Pang, S. W.; Yee, A. F. J Vac Sci Technol B 2004, 22, 2486-2492.
Tien, J., Nelson, C. M. & Chen, C. S. Fabrication of aligned microstructures with a single elastomeric stamp. Proceedings of the National Academy of Sciences of the United States of America 99, 1758-1762 (2002).
Volynskii, A. L.; Bazhenov, S.; Lebedeva, O. V.; Ozerin, A. N.; Bakeev, N. F. J Appl Polym Sci 1999, 72, 1267-1275.
Volynskii, A. L.; Bazhenov, S.; Lebedeva, O. V.; Bakeev, N. F. J Mater Sci 2000, 35, 547-554.
Wilbur, J. L., Kumar, A., Kim, E. & Whitesides, G. M. Microfabrication by Microcontact Printing of Self-Assembled Monolayers. Advanced Materials 6, 600-604 (1994).
Xia, Y. N. & Whitesides, G. M. Soft lithography. Annual Review of Materials Science 28, 153-184 (1998).
Xu, S., Miller, S., Laibinis, P. E. & Liu, G. Y. Fabrication of nanometer scale patterns within self-assembled monolayers by nanografting. Langmuir 15, 7244-7251 (1999).
Zaugg, F. G. & Wagner, P. Drop-on-demand printing of protein biochip arrays. Mrs Bulletin 28, 837-842 (2003).
Zhu, H. & Snyder, M. Protein chip technology. Current Opinion in Chemical Biology 7, 55-63 (2003).

We claim:

1. A method of producing a microstructure or a nanostructure, comprising:
obtaining an extended elastomer;
producing a pattern on the extended elastomer; and
allowing the extended elastomer to relax to convert the pattern to produce a microstructure or nanostructure.

2. A method of producing a microstructure or a nanostructure, comprising:
a) obtaining a first extended elastomer and a second extended elastomer;
b) producing a pattern on the first extended elastomer;
c) allowing the first extended elastomer to relax to convert the pattern to produce a first reduced-size pattern;
d) transferring the first reduced-size pattern to the second extended elastomer; and
e) allowing the second extended elastomer to relax to convert the first reduced-size pattern to produce a second reduced-size pattern.

3. The method of claim 2 further comprising repeating steps d and e using another extended elastomer as the second extended elastomer, wherein the second reduced-size pattern resulting from step e is used as the first reduced-size pattern of step d, and wherein steps d and e are repeated until the second reduced-size pattern produced is a microstructure or nanostructure.

4. A method of producing a microstructure or a nanostructure, comprising:
a) extending a first elastomer to produce a first extended elastomer;
b) producing a pattern on the first extended elastomer;
c) allowing the first extended elastomer to relax, to convert the pattern to produce a first reduced-size pattern;
d) extending a second elastomer to produce a second extended elastomer;
e) transferring the first reduced-size pattern to the second extended elastomer,
f) allowing the second extended elastomer to relax, to convert the first reduced-size pattern on the second extended elastomer to produce a second reduced-size pattern.

5. The method of claim 4, further comprising repeating steps d, e, and f using another extended elastomer as the second elastomer, wherein the second reduced-size pattern resulting from step f is used as the first reduced-size pattern of step e, and wherein steps d, e, and f are repeated until the second reduced-size pattern produced is a microstructure or nanostructure.

6. The method of claim 1, wherein the first elastomer, first, extended elastomer, second elastomer, and second extended elastomer each comprise one or more polymers.

7. The method of claim 6, wherein said polymer is selected from the group consisting of rubber, Poly(dimethylsiloxane) (PDMS), and latex, with and without surface modification.

8. The method of claim 2, wherein the first extended elastomer and second extended elastomer comprise different polymers.

9. The method of claim 1, wherein the pattern comprises a material selected from the group consisting of a biological material, nanoparticles, nanowires, nanotubes, metals, organic and inorganic materials, and composite materials.

10. The method of claim 9, wherein the pattern is a biological material comprising a material selected from the group consisting of peptides, proteins, ligands, oligosaccharides, nucleotides, viruses, antigen, and bacteria.

11. The method of claim 10, wherein the biological material is an antibody, or an antigen.

12. The method of claim 1, wherein the microstructure or the nanostructure comprises a mold for lithography.

13. The method of claim 1, wherein the pattern is created by means of a lithography platform, wherein the lithography platform is selected from the group consisting of photolithography, scanning probe lithography, inkjet printing, array technique, imprinting lithography, beam lithography, particle lithography, and microcontact printing.

14. The method of claim 1, wherein the microstructure or the nanostructure is used in microlithography and nanolithography.

15. The method of claim 2, wherein the transferring of the first reduced-size pattern between the elastomer surfaces is mediated by an external means, wherein said external means is selected from the group consisting of surface chemistry, surface plasma treatment, thermal treatment, electric field treatment, and magnetic field treatment.

16. The method of claim 1, wherein the extended elastomer is extended in at least one dimension.

17. The method of claim 1, wherein the extended elastomer is extended in at least two dimensions.

18. A microstructure or nanostructure produced by the method of claim 1.

19. A biomedical or electronic device comprising the microstructure or nanostructure of claim 18.

20. The method of claim 1, wherein the microstructure or the nanostructure is used in optical displays, sensors, biochips, microarrays, nanoarrays or fluidic devices.
